(19) United States
(12) Patent Application Publication
(10) Pub. No.: US 2024/0167304 A1
(43) Pub. Date: May 23, 2024

(54) LOCKING MECHANISM AND IMAGE FORMING APPARATUS EQUIPPED WITH LOCKING MECHANISM

(71) Applicant: KYOCERA Document Solutions Inc., Osaka (JP)

(72) Inventor: Geki SON, Osaka (JP)

(73) Assignee: KYOCERA Document Solutions Inc., Osaka (JP)

(21) Appl. No.: 18/282,047

(22) PCT Filed: Feb. 16, 2022
(86) PCT No.: PCT/JP2022/006115

§ 371 Date: Sep. 14, 2023

(30) Foreign Application Priority Data
Mar. 24, 2021 (JP) 2021-050282

(51) Int. Cl. E05C 3/14; E05C 3/00; G03G 21/16

(52) U.S. Cl. CPC E05C 3/14; E05C 3/008; G03G 21/1633

(57) ABSTRACT

A cover member includes: a fittable recess that opens to one side of the cover member in a direction orthogonal to an axis of a shaft member, receives a torsion coil spring from the one side, and fits on an outer periphery of the torsion coil spring; and an anchoring counter element to which one end of the torsion coil spring is anchored. The torsion coil spring is engaged with a hook member while being fitted in the fittable recess, thus biasing the hook member toward movement about the axis of the shaft member to a locking position and supporting both ends of the shaft member rotatably around an internal surface of the coil to function as a bearing member.

### TECHNICAL FIELD

The present invention relates to locking mechanisms and image forming apparatuses equipped with a locking mechanism.

### BACKGROUND ART

Generally, a structure is known in which hook members are used as a locking mechanism for a cover member pivotally movable about one edge of the cover member as a fulcrum (see, for example, Patent Literature 1). This locking mechanism includes a shaft member which extends along the other edge of the cover member opposed to the one edge thereof and is rotatably supported at both ends by the cover member. The hook members with respective engageable hook portions formed at their distal ends are fixed to the shaft member unitarily rotatably with the shaft member. When an access cover is moved to its closed position, the engageable hook portions of the hook members engage with an engageable counterpart provided in a specific location. The hook members are biased, by a biasing member, toward engagement of the engageable hook portions with the engageable counterpart to establish a locking position. A manually operable portion for unlocking the locking mechanism is provided on the cover member. When the manually operable portion is operated, the shaft member rotates toward an unlocking position against the biasing force of the biasing member, which disengages the engagement of the engageable hook portions of the hook members with the engageable counterpart. Both the ends of the shaft member are supported through respective bearing members by the cover member.

### CITATION LIST

### Patent Literature

Patent Literature 1: JP-A-2010-127997

### SUMMARY OF INVENTION

However, the locking mechanism disclosed in Patent Literature 1 requires the bearing members for bearing both ends of the shaft member, which increases the number of parts and thus presents a problem of cost rise.

The present invention has been made in view of the foregoing point and has an object of reducing the number of parts of a locking mechanism including a hook member fixed unitarily rotatably to a shaft member and a biasing member biasing the hook member toward movement about the shaft member by devising the structure of the locking mechanism, thus reducing the production cost.

A locking mechanism according to an aspect of the present invention includes: a cover member openable and closable by pivotally moving about one edge of the cover member as a fulcrum; a shaft member extending along an edge of the cover member opposed to the one edge of the cover member and rotatably supported at both ends by the cover member; a hook member coupled unitarily rotatably to the shaft member and having an engageable hook portion formed at a distal end thereof; an engageable counterpart capable of locking the cover member by engaging with the engageable hook portion of the hook member when the cover member moves to a closed position; a torsion coil spring biasing the hook member toward a locking position of the cover member where the engageable hook portion engages with the engageable counterpart; and a manually operable portion capable of being manually operated with the cover member in the closed position to rotate the shaft member to disengage the engageable hook portion from the engageable counterpart. The cover member includes: a fittable recess that opens to one side of the cover member in a direction orthogonal to an axis of the shaft member, receives the torsion coil spring from the one side, and fits on an outer periphery of the torsion coil spring; and an anchoring counter element to which one end of the torsion coil spring is anchored. The torsion coil spring is engaged with the hook member while being fitted in the fittable recess, thus biasing the hook member toward movement about the axis of the shaft member to the locking position and supporting both the ends of the shaft member rotatably around an internal surface of the coil.

An image forming apparatus according to another aspect of the present invention includes the above-described locking mechanism, a main body provided with the engageable counterpart, and an image forming device that forms an image on a recording medium.

### Advantageous Effects of Invention

The present invention reduces the number of parts of a locking mechanism including a hook member fixed unitarily rotatably to a shaft member and a biasing member biasing the hook member toward movement about the shaft member, thus enabling reduction in production cost.

### BRIEF DESCRIPTION OF DRAWINGS

FIG. 1 is an external perspective view showing an image forming apparatus including a locking mechanism according to an embodiment of the present invention.

FIG. 2 is an external perspective view showing the image forming apparatus when a main cover is open.

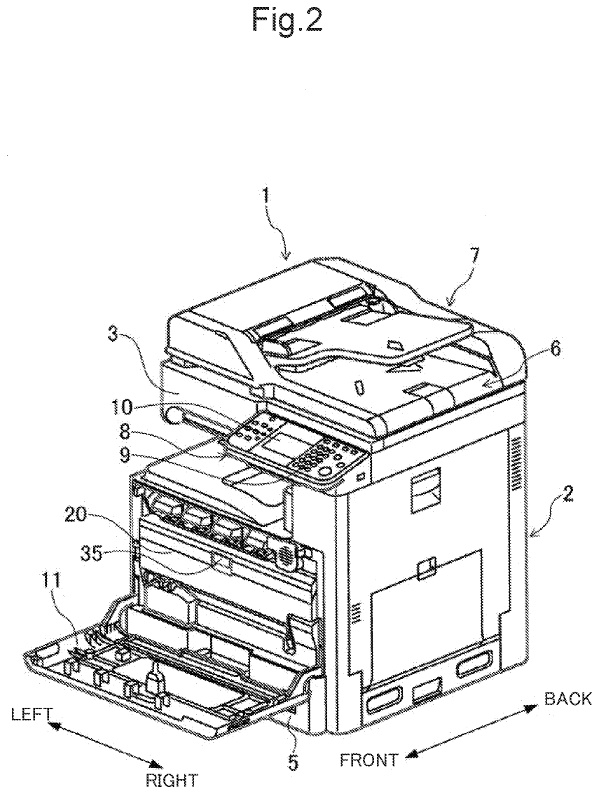

FIG. 3 is a perspective view of an access cover when viewed from the front side.

FIG. 4 is a perspective view of the access cover when viewed from the back side.

FIG. 5 is a cross-sectional view taken along the line V-V in FIG. 4.

FIG. 6 is a cross-sectional view taken along the line VI-VI in FIG. 4.

FIG. 7 is an enlarged view showing the portion VII in FIG. 4 on an enlarged scale.

FIG. 8 is a view from the direction of the arrow VIII in FIG. 7.

FIG. 9 is a view from the direction of the arrow IX in FIG. 7.

FIG. 10 is a view from the direction of the arrow X in FIG. 7.

### DESCRIPTION OF EMBODIMENTS

Hereinafter, a description will be given of embodiments of the present invention with reference to the drawings. However, the present invention is not limited to the following embodiments.

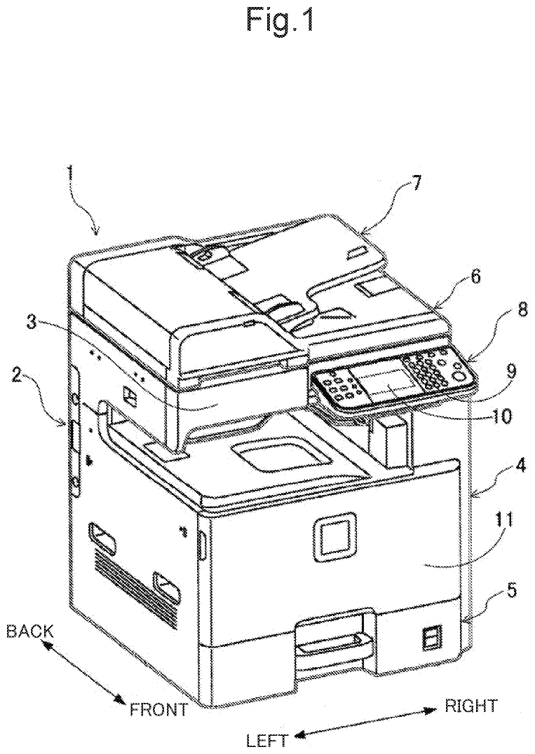

FIG. 1 shows an image forming apparatus 1 including a locking mechanism according to an embodiment of the present invention. The image forming apparatus 1 is an all-in-one image forming apparatus (a multifunction peripheral) having not only a print function but also a scan function, a facsimile function, and a copy function. In the following description, the terms “front” and “back” means the front side and back side, respectively, of the image forming apparatus 1 and the terms “left” and “right” means the left side and right side, respectively, of the image forming apparatus 1 when viewed from the front side.

[Entire Structure]

The image forming apparatus 1 includes an image forming apparatus body 2 and an image reading device 3 disposed on top of the body 2. The image forming apparatus body 2 includes: a printing device 4 disposed in the middle of the body 2 in a top-to-bottom direction thereof, and a sheet feed cassette 5 disposed under the printing device 4. Sheets are contained in the sheet feed cassette 5. The printing device 4 (the image forming device) does printing (image formation), based on predetermined image data, on a sheet as a recording medium fed from the sheet feed cassette 5. The printing process adopted in the printing device 4 is, for example, an electrophotographic process. Specifically, the printing device 4 includes four photosensitive drum units associated with different colors: yellow, cyan, magenta, and black. In each photosensitive drum unit, the surface of a photosensitive drum is irradiated with laser light corresponding to image data to form an electrostatic latent image and the electrostatic latent image is developed by a toner of the associated color. The respective developed toner images of different colors are primarily transferred to the surface of an intermediate transfer belt, superposed on one another, and then secondarily transferred to a sheet fed from the sheet feed cassette 5.

The four photosensitive drum units are contained side by side in the right-and-left direction in the interior of the image forming apparatus body 2 and structured to be insertable into and withdrawable from the image forming apparatus body 2 through the front side thereof. An access cover 20 (an example of the cover member) is provided in front of a containing space for the four photosensitive drum units. The access cover 20 is provided on the internal side of a main cover 11 covering the front side of the image forming apparatus body 2. The access cover 20 is locked in its closed position by a locking mechanism 30 to be described hereinafter.

The image reading device 3 optically reads an image of an original document placed on an original glass plate forming the top surface of the image reading device 3. The top surface of the image reading device 3 is covered openably and closably by a document holding cover 6 for holding the original document. The document holding cover 6 is integrated with an automatic document feed device 7. The automatic document feed device 7 conveys along a predetermined conveyance path an original document loaded on a document feed tray, allows the original document to pass through an image reading position set on the original glass plate, and then ejects the original document onto a document ejection tray. An operation panel 8 is formed on and extends from the front surface of the image reading device 3. The operation panel 8 is provided with: an operation device 9 including a numeric keypad and a Start key; and a display device 10 formed of a liquid crystal display.

### [Structure of Access Cover]

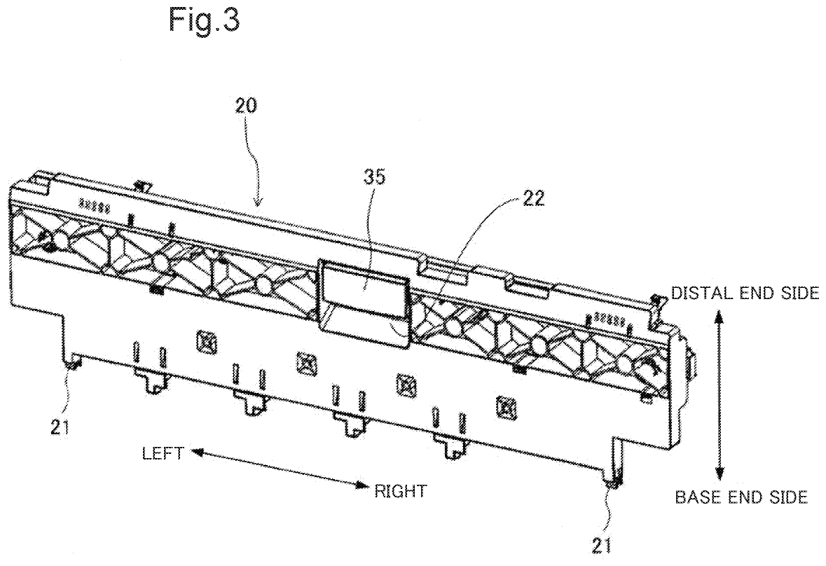

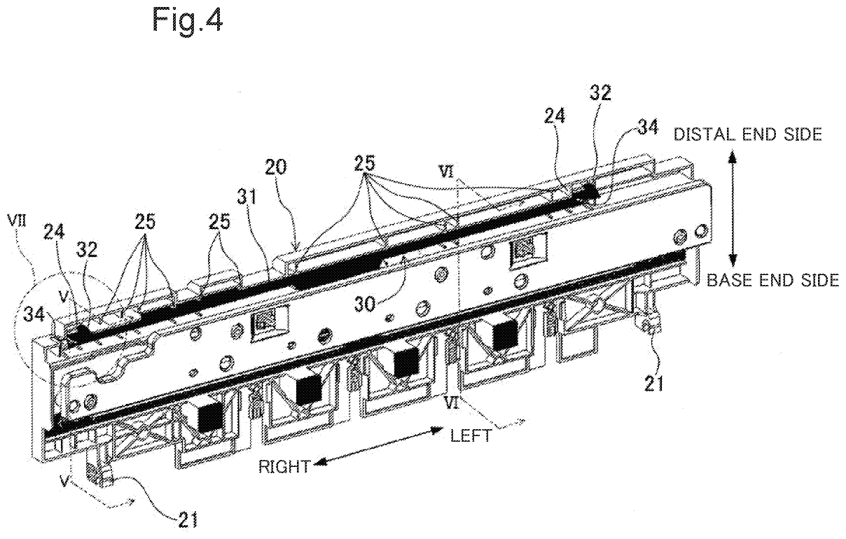

FIG. 3 is a perspective view of the access cover 20 when viewed from the front side, and FIG. 4 is a perspective view of the access cover 20 when viewed from the back side. The access cover 20 is made of a resin member in a rectangular plate-like shape elongated in the right-and-left direction. Downwardly open U-shaped engaging fulcrum portions 21 are formed at both ends of a base edge of the access cover 20 in the right-and-left direction. The right and left engaging fulcrum portions 21 engage with right and left support shafts, respectively, provided on the image forming apparatus body 2. Each of the support shafts extends horizontally in the right-and-left direction. The access cover 20 is designed to be openable and closable relative to the front side of the above-described containing space by pivotally moving with the right and left support shafts as a fulcrum. In the following description, the side of the access cover 20 where the right and left engaging fulcrum portions 21 are provided is defined as a base end side, while the opposite side to the base end side is defined as a distal end side.

As shown in FIG. 3, a manually operable lever 35 (an example of the manually operable device) is provided in a recess 22 provided in the middle of an external surface of the access cover 20 in the right-and-left direction. The manually operable lever 35 passes through the access cover 20 and is coupled unitarily rotatably to a shaft member 31 of the locking mechanism 30 to be described hereinafter.

As shown in FIG. 4, a pair of end vertical ribs 24 and a plurality of intermediate vertical ribs 25 are formed on a distal end edge of the internal surface of the access cover 20 (an edge thereof opposite to the base end side of the access cover 20).

The pair of end vertical ribs 24 are provided at both the right and left ends of the distal end edge of the access cover 20.

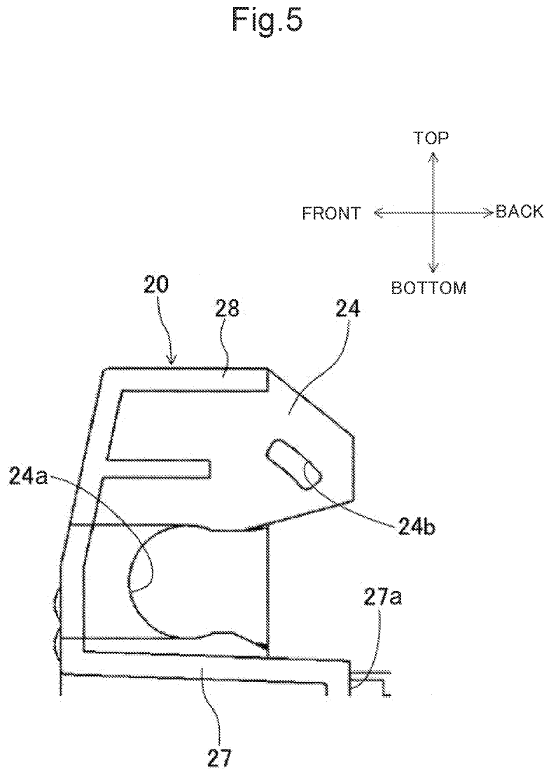

The plurality of intermediate vertical ribs 25 are provided between the pair of end vertical ribs 24 and arranged at spaced intervals in the right-and-left direction. Each of the end vertical ribs 24 and the plurality of intermediate vertical ribs 25 is provided, as shown in FIG. 5, between a horizontal rib 27 extending along the distal end edge of the access cover 20 and a distal end sidewall 28 of the access cover 20.

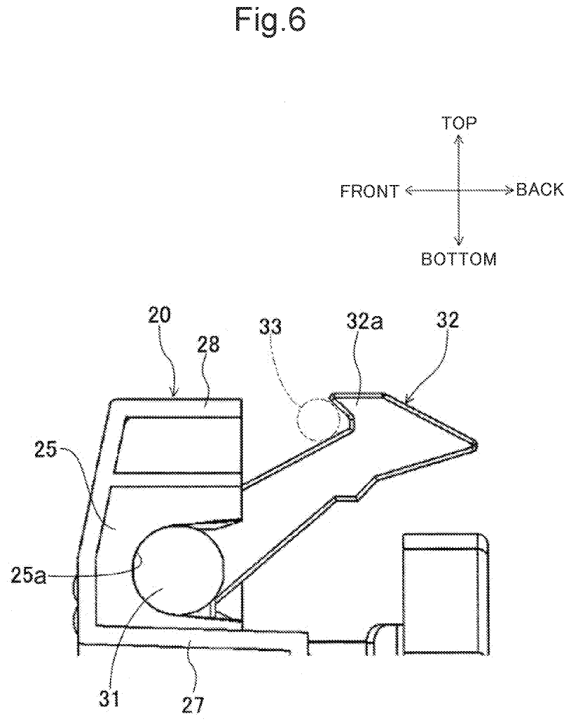

As shown in FIGS. 5 and 6, each of the end vertical ribs 24 and intermediate vertical ribs 25 has a U-shaped bearing recess 24a, 25a formed to open to the internal side of the apparatus.

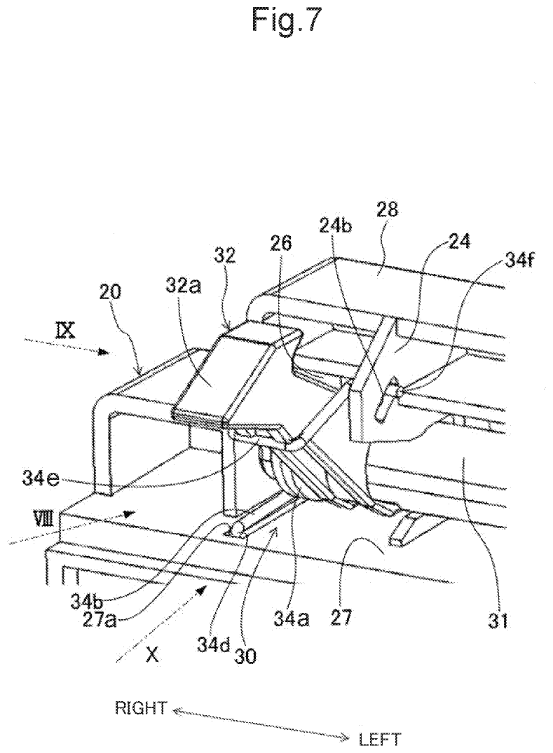

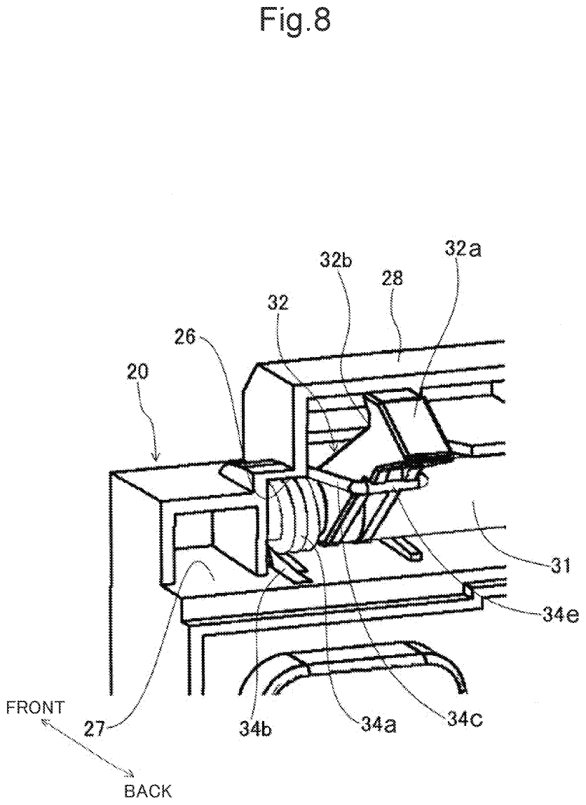

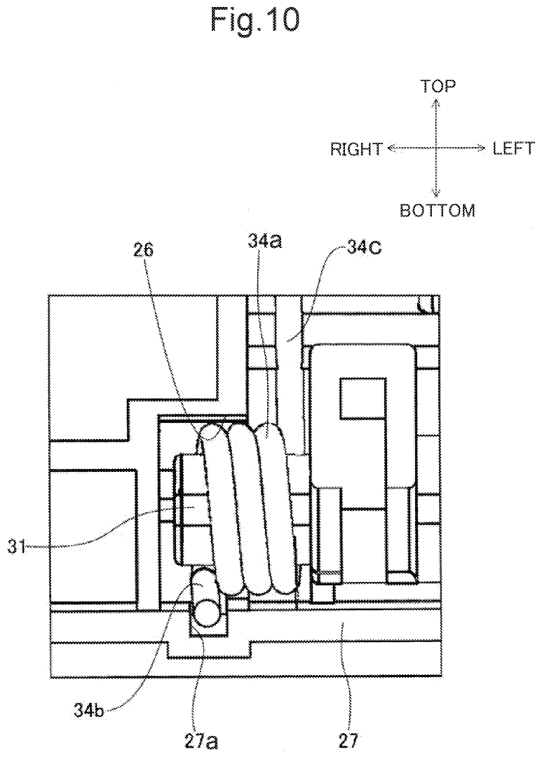

As shown in FIGS. 7 to 10, spring fittable recesses 26 into each of which a torsion coil spring 34 of the locking mechanism 30 to be described hereinafter is to be fitted are formed lateral to the pair of end vertical ribs 24 in the right-and-left direction. The spring fittable recess 26 is formed of a U-shaped recess formed coaxially with the bearing recesses 24a, 25a and opening to the internal side of the apparatus.

[Structure of Locking Mechanism]

Next, the locking mechanism 30 will be described in detail with reference to FIGS. 7 to 10. Each of the figures shows a state where the access cover 20 is in a closed position. Hereinafter, unless otherwise stated, the description will be given on the assumption that the access cover 20 is in a closed position.

The locking mechanism 30 includes: a shaft member 31 mounted to the distal end edge of the access cover 20; right and left hook members 32 fixed unitarily rotatably to the shaft member 31, and right and left torsion coil springs 34 biasing the respective associated hook members 32 toward movement about the shaft member 31.

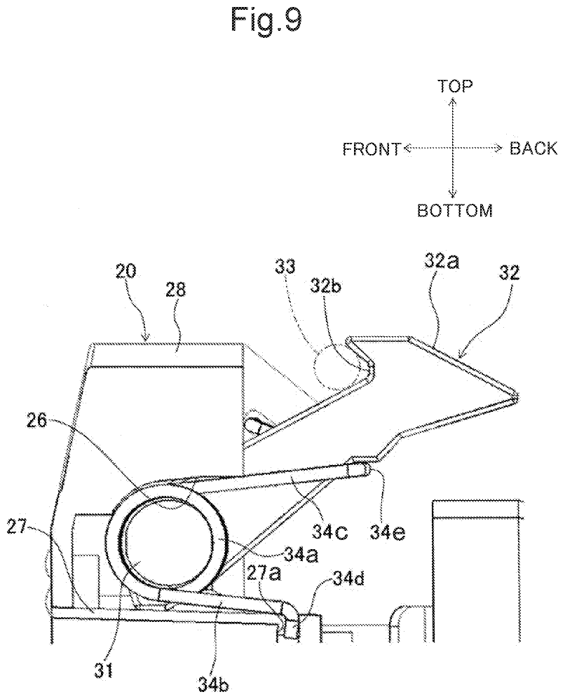

Each of the hook members 32 is inclined downwardly toward the back side when viewed from the direction of the axis of the shaft member 31. Each of the hook members 32 has a shape that its distal end is pointed at a sharp angle when viewed from the direction of the axis of the shaft member 31. An inclined surface 32a inclined downwardly toward the back side is formed on a back side portion of a top end surface of the hook member 32. An upper end portion of a front end surface of the hook member 32 is provided with a V-shaped engageable recess 32b formed to be depressed backward. Each of the hook members 32 is always biased toward upward (counterclockwise in FIG. 9) movement about the shaft member 31 by the torsion coil spring 34.

When the access cover 20 is pivotally moved from its open position toward its closed position (from the left to the right in FIG. 9), the inclined surfaces 32a of the hook members 32 abut on an engageable counterpart shaft 33 (see FIG. 9) provided in the interior of the image forming apparatus body 2. When the access cover 20 is further pivotally moved toward the closed position, the inclined surfaces 32a are pressed downward by the engageable counterpart shaft 33 and, thus, the hook members 32 rotate clockwise in FIG. 9 together with the shaft member 31. Then, when the access cover 20 reaches the closed position (the position in FIG. 9), the top end surfaces of the hook members 32 have passed over the engageable counterpart shaft 33. Thus, the hook members 32 return to their original positions by the biasing force of the torsion coil springs 34. As a result, the engageable recesses 32b (the engageable hook portions) of the hook members 32 engage with the engageable counterpart shaft 33 (the engageable counterpart), so that the access cover 20 is locked against opening. In unlocking the access cover 20, it is only necessary to pull up frontward the manually operable lever 35 (see FIG. 3) provided on the access cover 20. Thus, the shaft member 31 coupled to the manually operable lever 35 is pivotally moved clockwise in FIG. 9, which disengages the engagement of the hook members 32 with the engageable counterpart shaft 33.

In a general locking mechanism, both ends of the shaft member are borne by the bearing members, which increases the number of parts and thus presents a problem of cost rise. To avoid this problem, in this embodiment, the locking mechanism is devised in terms of the mounting structures of the shaft member 31 and the torsion coil springs 34.

[Details of Mounting Structures of Shaft Member 31 and Torsion Coil Springs 34]

The shaft member 31 is disposed to fit in the bearing recesses 24a of both the end vertical ribs 24 and the bearing recesses 25a of the intermediate vertical ribs 25. Both ends of the shaft member 31 extend laterally beyond both the end vertical ribs 24 and are fitted (inserted) into and supported by the right and left torsion coil springs 34. The right and left torsion coil springs 34 function as bearing members that bear both ends of the shaft member 31.

The torsion coil spring 34 includes a spring body 34a, a first linear portion 34b, a second linear portion 34c, a bent anchoring portion 34d, a hook member engagement portion 34e, and a guide slit engagement portion 34f.

The spring body 34a is a helical portion generating a restoring force in the direction of torsion and has an approximately cylindrical shape in appearance. The spring body 34a is disposed so that the outer periphery of the spring body 34a comes into close contact with the inner periphery of the spring fittable recess 26.

The first linear portion 34b and the second linear portion 34c extend from both ends of the spring body 34a in the direction of the tangent to the spring body 34a. The first linear portion 34b extends backward from a lower end of the spring body 34a when viewed from the direction of the axis of the spring body 34a. The second linear portion 34c extends backward from an upper end of the spring body 34a when viewed from the direction of the axis of the spring body 34a.

The bent anchoring portion 34d is continued to a distal end of the first linear portion 34b and bent therefrom downward (toward an example of the direction orthogonal to the direction of the axis of the shaft member 31). As shown in FIG. 9, the bent anchoring portion 34d abuts on a backside wall surface of an engageable recess 27a (an example of the anchoring counter element) formed in the horizontal rib 27. Thus, the spring body 34a of the torsion coil spring 34 is given a reaction force to thrust the spring body 34a frontward through the bent anchoring portion 34d.

The hook member engagement portion 34e is continued to a distal end of the second linear portion 34c and bent-formed to surround the hook member 32. The hook member engagement portion 34e bears against the hook member 32 from below. Thus, the hook member 32 is always biased upward by the torsion coil spring 34.

The guide slit engagement portion 34f extends from an end of the hook member engagement portion 34e along the direction of the axis of the shaft member 31 (the right-and-left direction). A distal end of the guide slit engagement portion 34f passes through a guide slit 24b (see FIG. 7) formed in an associated one of both the end vertical ribs 24. The guide slit 24b guides the associated guide slit engagement portion 34f to allow arc movement of the guide slit engagement portion 34f therein in association with swing movement of the hook member 32.

### Effects

As thus far described, in this embodiment, the torsion coil springs 34 are engaged with the hook members 32 while being fitted in the spring fittable recesses 26, thus biasing the hook members 32 toward movement about the axis of the shaft member 31 to the locking position and supporting both the ends of the shaft member 31 rotatably around the internal surface of the coil to function as bearing members.

With this structure, since the torsion coil springs 34 for use in biasing the hook members 32 toward the locking position are also used as bearing members supporting the shaft member 31, the number of parts can be reduced and thus the production cost can be reduced.

In the above embodiment, the torsion coil spring 34 includes the helical spring body 34a, the first and second linear portions 34b, 34c extending from both ends of the spring body 34a in the direction of the tangent of the spring body 34a, and the bent anchoring portion 34d continued to the first linear portion 34b, bent in the direction orthogonal to the axis of the spring body 34a, and engaged and anchored in the engageable recess 27a. The torsion coil spring 34 is designed to thrust the spring body 34a into the spring fittable recess 26 by a reaction force applied to the bent anchoring portion 34d from the wall surface of the engageable recess 27a.

With this structure, the torsion coil spring 34 can be securely anchored in the spring fittable recess 26. As a result, the torsion coil spring 34 can be prevented from being fallen off or causing backlash owing to the rotation of the shaft member 31.

In the above embodiment, the access cover 20 includes an arcuate guide slit 24b that guides the other end (the guide slit engagement portion 34f) of the torsion coil spring 34 to allow movement of the other end therein in association with swing movement of the hook member 32.

With this structure, since the other end of the torsion coil spring 34 is guided (supported) by the guide slit 24b, the torsion coil spring 34 can be more securely prevented from falling off and causing backslash.

### Other Embodiments

Although in the above embodiment the locking mechanism 30 is applied to the image forming apparatus 1, the present invention is not limited to the above embodiment. The locking mechanism 30 may be applied to any apparatus so long as it includes an access cover 20.

### INDUSTRIAL APPLICABILITY

The present invention is useful for a locking mechanism and an image forming apparatus with the locking mechanism and useful particularly when applied to a printer, a facsimile machine, a copier, a multifunction peripheral (MFP) or the like.

1. A locking mechanism comprising:
a cover member openable and closable by pivotally moving about one edge of the cover member as a fulcrum;
a shaft member extending along an edge of the cover member opposed to the one edge of the cover member and rotatably supported at both ends by the cover member;
a hook member coupled unitarily rotatably to the shaft member and having an engageable hook portion formed at a distal end thereof;
an engageable counterpart capable of locking the cover member by engaging with the engageable hook portion of the hook member when the cover member moves to a closed position;
a torsion coil spring biasing the hook member toward a locking position of the cover member where the engageable hook portion engages with the engageable counterpart; and
a manually operable portion capable of being manually operated with the cover member in the closed position to rotate the shaft member to disengage the engageable hook portion from the engageable counterpart,
the cover member comprising:
a fittable recess that opens to one side of a direction orthogonal to an axis of the shaft member, receives the torsion coil spring from the one side, and fits on an outer periphery of the torsion coil spring; and
an anchoring counter element to which one end of the torsion coil spring is anchored,
wherein the torsion coil spring is engaged with the hook member while being fitted in the fittable recess, thus biasing the hook member toward movement about the axis of the shaft member to the locking position and supporting both the ends of the shaft member rotatably around an internal surface of the coil.

2. The locking mechanism according to claim 1, wherein
the cover member comprises an engageable recess as the anchoring counter element,
the torsion coil spring comprises a helical spring body, first and second linear portions extending from both ends of the spring body in a direction of a tangent of the spring body, and a bent anchoring portion continued to the first linear portion, bent in a direction orthogonal to an axis of the spring body, and engaged and anchored in the engageable recess, and
the torsion coil spring is designed to thrust the spring body into the fittable recess by a reaction force applied to the bent anchoring portion from a wall surface of the engageable recess.

3. The locking mechanism according to claim 2, wherein the cover member further comprises an arcuate slit that guides another end of the torsion coil spring to allow movement in the slit in association with swing movement of the hook member.

4. The locking mechanism according to claim 2, wherein the torsion coil spring further comprises a hook member engagement portion continued to a distal end of the second linear portion and bent-formed to surround the hook member and the hook member engagement portion bears against the hook member.

5. An image forming apparatus comprising:
the locking mechanism according to claim 1;
a main body provided with the engageable counterpart; and
an image forming device that forms an image on a recording medium.
